(19) United States
(12) Patent Application Publication
(10) Pub. No.: US 2025/0263182 A1
(43) Pub. Date: Aug. 21, 2025

(54) UAV System And A Method For Survey And Detection Of Magnetized Unexploded Ordnance

(71) Applicant: Sokil, Inc., Redmond, WA (US)

(72) Inventors: Xander Edward Fries, Redmond, WA (US); Ivan Dudiak, Claremont, CA (US); Sorin Asoka-Patrick Jayaweera, Claremont, CA (US); Christopher Douglas Cotner, Snohomish, WA (US)

(21) Appl. No.: 19/056,668

(22) Filed: Feb. 18, 2025

Related U.S. Application Data
(60) Provisional application No. 63/648,658, filed on May 16, 2024.
(60) Provisional application No. 63/555,086, filed on Feb. 18, 2024.

(51) Int. Cl. B64U 10/14; B64U 20/00; B64U 50/23; B64U 101/00

(52) U.S. Cl. CPC B64U 10/14; B64U 20/00; B64U 50/23; B64U 2101/00; B64U 2101/10; B64U 2201/10

(57) ABSTRACT

An aerial vehicle system for detecting magnetized objects comprises a propulsion system and sensor bar having magnetic field sensors at opposite ends to collect magnetic field data. In one example, the sensor bar extends at least one and a half times the propulsion system's length. The system further includes a positioning system, an altitude sensor, and an energy storage system. A processor executes flight instructions to navigate the aerial vehicle along a predefined path, collecting magnetic field and position data. A magnetic field information analyzer processes this data, generating expected magnetic signatures, comparing them to collected data, and predicting magnetized object locations. A user interface allows flight path customization and overlays detected objects onto a map of the surveyed area. The system can identify unexploded ordnance and landmines by comparing detected signals to predefined thresholds. The method includes controlling flight, collecting magnetic data, and analyzing signals to detect magnetized objects.

### CROSS REFERENCE TO RELATED APPLICATIONS

This application claims the benefit under 35 U.S.C. § 119 from U.S. Provisional Patent Application Ser. No. 63/555,086, entitled “UAV survey system for detecting unexploded ordnance,” filed on Feb. 18, 2024, the subject matter of which is incorporated herein by reference. This application also claims the benefit under 35 U.S.C. § 119 from U.S. Provisional Patent Application Ser. No. 63/648,658, entitled “Algorithm and System for Detecting Magnetic Dipoles from a UAV,” filed on May 16, 2024, the subject matter of which is incorporated herein by reference.

### TECHNICAL FIELD

The present disclosure relates to aerial vehicle systems, and more particularly to unmanned aerial vehicles (UAVs) equipped with magnetic field sensors for detecting and analyzing magnetized objects within a geographic area.

### BACKGROUND INFORMATION

Landmines and Unexploded Ordnance (UXO) are threats that polluted the world since the First World War, contaminating 560000 km2 worldwide—larger than California. In Ukraine, as a consequence of the Russian invasion, the area, potentially contaminated with landmines, if cultivated, could feed 100 million people. The total economic impact on Ukraine in loss of potential profits from landmine contamination is estimated at 800 million USD annually (Osmolovska and Bilyk, 2024). There are also dire humanitarian consequences, with 877 civilian casualties suffered in Ukraine just in 2023 (Osmolovska and Bilyk, 2024).

Current methods of landmine detection in Ukraine are very slow, involve humans for operation, often have high false positive and false negative rates, and are expensive (World Bank, 2023). The most frequent method is a human-held metal detector that has to be swept over the area. The metal detectors are very sensitive to any metal so according to the data in Cambodia, sappers detect 100-1000 metal objects per every detected mine (Hewish and Pengelley, 1997). Given the close proximity of sappers to the mines, the work is tedious, dangerous, and very slow. Using traditional sources, it would take Ukraine several hundred years to demine (Osmolovska and Bilyk, 2024).

A large part of the problem lies in the TM-62M anti-tank landmine. It is one of the most prevalent and dangerous mines, which results in a lot of casualties and equipment loss. It is a steel mine and is typically buried centimeters below the ground, but it produces large magnetic fields, making detection via aerial magnetometry appealing. Magnetometry is also appealing for the detection of unexploded ordnance (UXO) such as artillery shells or gliding bombs, many of which have not exploded at impact. They are usually characterized by a strong magnetic field, visible to magnetometry systems.

The complexity of new technologies often comes with a significant burden by the need to have a technical professional operating the system, quickly becoming a preventive factor for the adoption by demining groups.

UAV-based sensing systems have recently seen a major interest as they promise to provide a non-invasive quick way of performing a Non-technical survey of the territory and accelerating the land release. There has been success from companies like SafePro, performing visual detection with UAVs (SafePro, 2024). However, such systems have limitations in being able to detect obstructed landmines, underground, under snow, or vegetation. Magnetometry can provide some of the missing information in that equation.

### SUMMARY

An aerial vehicle system for detecting magnetized objects comprises a propulsion system and sensor bar having magnetic field sensors at opposite ends to collect magnetic field data. In one example, the sensor bar extends at least one and a half times the propulsion system's length. The system further includes a positioning system, an altitude sensor, and an energy storage system. A processor executes flight instructions to navigate the aerial vehicle along a predefined path, collecting magnetic field and position data. A magnetic field information analyzer processes this data, generating expected magnetic signatures, comparing them to collected data, and predicting magnetized object locations. A user interface allows flight path customization and overlays detected objects onto a map of the surveyed area. The system can identify unexploded ordnance and landmines by comparing detected signals to predefined thresholds. The method includes controlling flight, collecting magnetic data, and analyzing signals to detect magnetized objects.

The systems, methods, and devices of the various embodiments provide an aerial magnetized object detection system that includes an aerial vehicle equipped with a magnetic sensor bar sufficiently long to ensure adequate differential magnetic field signal magnitude at the flight altitude. Algorithms are disclosed that combine magnetic field measurements from multiple locations using templates of expected magnetic fields to improve magnetized object detection capability. A method is also disclosed of using the optimized magnetic sensor bar and detection algorithms to automatically detect ferrous material by controlling the aerial vehicle.

Magnetometry UAV survey systems exist, however they are characterised by high cost and complexity of operation. Usually, the method of operation involves simply overlaying magnetic field data over a geographic area, with limited data processing. In addition, the software processing data is usually disjoint from the software directing the UAV flight and both typically require a depth of technical understanding of electromagnetism and data science. Those factors contribute to low accessibility of such systems both from financial and operational standpoints. In accordance with various novel aspects, the novel systems and methods create an accessible system that minimizes cost through extensive data processing with a matched-filter method and maximise usability by providing an all-in-one software allowing to operate the aerial vehicle and process data for a user with little technical experience.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention

FIG. 1 illustrates an embodiment system for detecting magnetized objects remotely with magnetic field sensors mounted to an aerial vehicle.

FIG. 2 illustrates an embodiment aerial vehicle equipped with a large magnetic sensor bar for high sensitivity differential magnetometry measurements.

FIG. 3 shows an example of the magnetic dipole field magnitude generated by a magnetized object.

FIGS. 4 and 5 show graphs which demonstrate how the signal strength of a differential magnetometry system increases when the spacing between sensors is large relative to the flight altitude.

FIG. 6 is a diagram showing a flight path of the areal vehicle over a geographic area in accordance with one embodiment.

FIG. 7 illustrates the operation of the matched filter algorithm for detecting magnetized objects using the expected magnetic field signatures to fuse together multiple measurements from different locations.

FIG. 8 is a graph of signal to noise ratio versus flight altitude for different detection methods, illustrating how the embodiment matched filter algorithms using expected magnetic field signatures improve detection signal to noise ratio compared to conventional methods.

FIG. 9 is a process flow diagram illustrating an embodiment magnetic field data analysis method to determine the presence, location and properties of magnetized objects from flight data.

FIG. 10 is a graph of the calibrated, filtered and rotation-corrected magnetic field data from a 3-axis magnetic field sensor during flight.

FIG. 11 is a graph of the aerial vehicle flight path and potential object locations near the flight path which are evaluated by the embodiment magnetic field data analysis method.

FIGS. 12 and 13 show example graphs of a differential 3-axis 2D magnetic field template for a particular potential object location.

FIG. 14 is a graph of an embodiment detection metric map with detected object locations labeled.

FIG. 15 is a process flow diagram illustrating an embodiment differential magnetic field sensor calibration method.

FIG. 16 is a process flow diagram illustrating an embodiment magnetized object detection method.

### DETAILED DESCRIPTION

Reference will now be made in detail to some embodiments of the invention, examples of which are illustrated in the accompanying drawings.

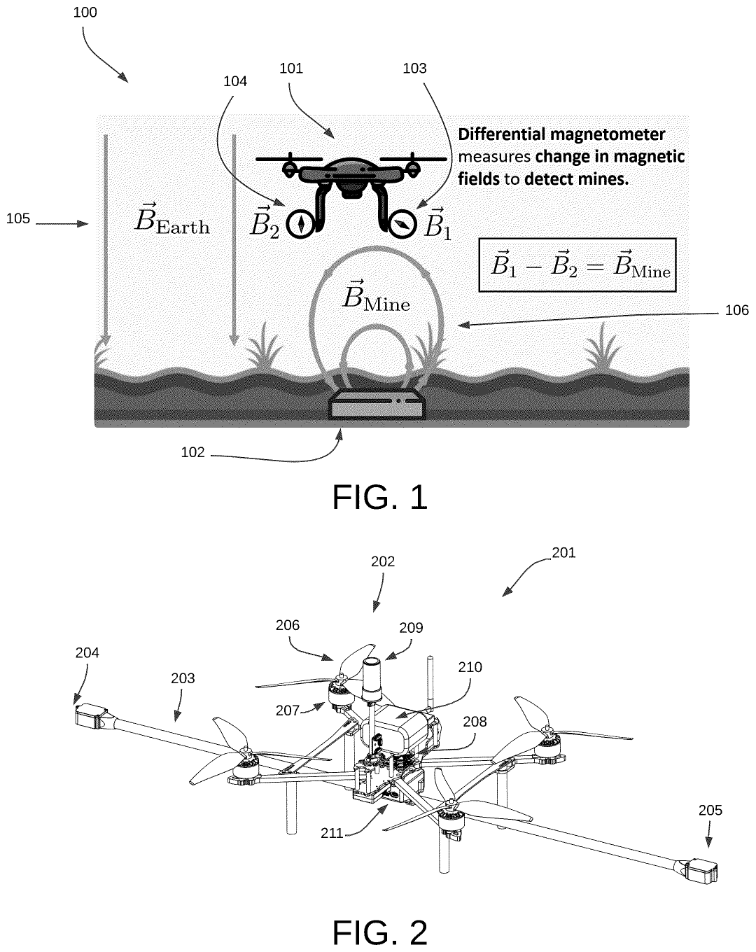

FIG. 1 illustrates an example remote magnetized object detection system 100, used to detect the presence of magnetized objects by measuring variations in the magnetic field. An aerial vehicle 101 follows a flight path over a magnetized object 102, while recording magnetic field measurements using a first magnetic sensor 103 and a second magnetic sensor 104. The background magnetic field 105, for example due to the Earth's innate magnetic field, is very strong compared to the magnetized object magnetic field 106. However, the background magnetic field 105 does not change appreciably over a small distance, while the magnetized object's magnetic field 106 has high curvature and is localized to a small area. By taking the difference between magnetic field measurements from the first magnetometer 103 and the second magnetometer 104, the static background magnetic field 105 may be eliminated, leaving only spatially varying magnetic signatures such as the magnetized object's magnetic field 106. Although it is possible to observe a magnetized object's magnetic field using a single magnetic field magnitude sensor (a scalar magnetometer only observing the strength of the magnetic field) despite the strong contribution from the background field 105, it is difficult to do the same with a single 3-axis magnetometer (measuring the full magnetic field vector) because the tilting of the aerial vehicle causes the background field to rotate in the magnetometer's frame of reference, creating a noise component that is usually much stronger than the magnetized object's field 106. This is one reason differential magnetometry is useful specifically for aerial vehicles, because noise due to small oscillations in the vehicle orientation may be effectively removed. More than 2 magnetic field sensors may be used, and the background field may be eliminated by taking multiple differences between magnetic field sensors.

FIG. 2 illustrates an example aerial vehicle 201, which is equipped with a propulsion system 202 comprising four motors 207 and propellers 206. A sensor bar 203 is mounted to the aerial vehicle 201, with a first magnetic sensor 204 and a second magnetic sensor 205 disposed at opposite ends of the sensor bar 203. A processor 208 may control the propulsion system 202 to fly the aerial vehicle 201 along a flight path based using position measurements from the positioning system 209 and altitude sensor 211. The aerial vehicle may be powered by an energy storage device 210. In one embodiment, the processor 208 may manage and record data from the magnetic sensors 204 and 205. In another embodiment, there is an auxiliary processor separate from the first processor 208 which is responsible for recording data from the magnetic sensors 204 and 205. In one embodiment, the positioning system 209 is a GPS, such as an RTK GPS to obtain high accuracy position measurements. Observe that the sensor bar 203 is longer than the extent of the propulsion system, to improve the sensitivity of the differential magnetic sensing as explained below.

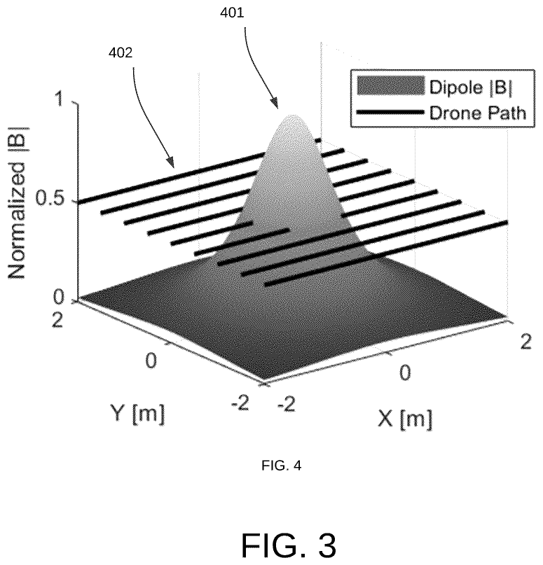

FIG. 3 illustrates an example of the expected dipole field magnitude 401 from a magnetized object on the ground, as measured by a sensor at 1 meter altitude following the sensor path 402. The dipole field magnitude 401 decays to zero far from the magnetized object, but is nonzero in the region where the horizontal position of the sensor is close to that of the object. The differential magnetometer sensing scheme of the detection system 100 is essentially sampling the magnetic field from two different points on the sensor path 402. If the sensors 103 and 104 are very close together, they will observe nearly the same magnetic field reading, such that the differential measurement will be close to zero even in the region where the dipole field magnitude 401 is large. If the sensors are instead far apart, the magnetic field readings will not cancel, and the differential magnetic field measurement may even be larger than the single sensor magnetic field measurement. The dipole field is the expected magnetic field for all objects much smaller than the distance between the object and the sensor, which is typically the case for detecting point targets from aerial magnetometry surveys.

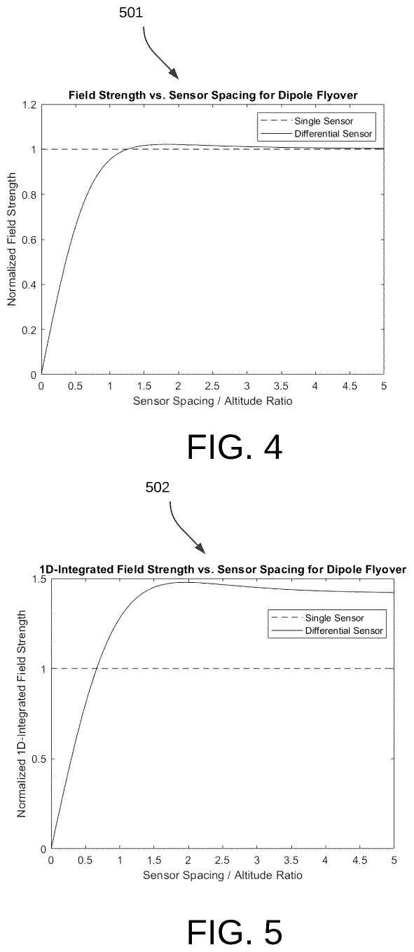

FIGS. 4 and 5 shows how the differential magnetic field measurement magnitude varies as a function of the spacing between sensors relative to the flight altitude when directly passing over a magnetized object. Two cases are shown. The plot of maximum field strength 501 shows the peak differential measurement magnitude during the flyover. The plot of integrated field strength 502 shows the root-sum-of-squares of the differential measurement magnitudes during a direct flyover, which is related to the operation of the algorithm discussed later. The integrated differential measurement can maintain similar signal strength to an integrated single sensor measurement, so long as the distance between sensors is at least roughly 0.66 times the flight altitude. With a large distance between sensors, the integrated differential measurement will approach the square root of 2, as expected for two independent measurements. A maximum exists with a sensor spacing of roughly 2 times the flight altitude, due to constructive interference between the sensor measurements. Both plots 501 and 502 demonstrate that the differential magnetic field sensing method acts as a spatial bandpass filter, and care should be taken in selecting the length of the sensor bar 203 such that the expected fields from magnetized objects are preserved or amplified rather than attenuated. Note that the dipole field attenuates as 1/r³, but for differential sensors with sensor spacing much smaller than the flight altitude, the slope on the left side of plots 501 and 502 may attenuate the differential signal further as altitude increases, at worst causing 1/r⁴ scaling.

As demonstrated in FIGS. 4 and 5, combining magnetic field measurements across multiple measurement positions can yield higher signal magnitude than using a single measurement, especially when differential sensors are used. This idea is extremely useful for conducting aerial magnetometry surveys, because the expected magnetic dipole field from magnetized objects attenuates as 1/r³, and high flight altitudes are often desired to clear vegetated or otherwise obstructed areas, so any methods to increase the signal to noise ratio (SNR) of the sensor will enable higher altitude flight and detection of smaller objects. Simply integrating the sensor measurements will help because, assuming independent sensor noise between measurements, sensor noise will add incoherently while the differential measurements add somewhat coherently; however, this is not optimal, because the differential measurements will sometimes destructively interfere, and the sensor noise will be included even in measurement positions where the expected magnetic field magnitude is zero. The optimal method for maximizing SNR in this situation is to use a matched filter, by applying a template representing the expected magnetic field measurements to weight the sum of differential measurements across the flight path. In order to apply matched filtering to the magnetic field data for magnetized object detection, suitable templates must be created to match all possible magnetized object configurations and locations of interest for the particular flight path of the aerial vehicle, and the outputs of matched filtering with the templates must be combined in a way to generate a reliable indicator of object presence. Ideally, the matched filtering would also improve the altitude scaling of the SNR to enable higher altitude operation.

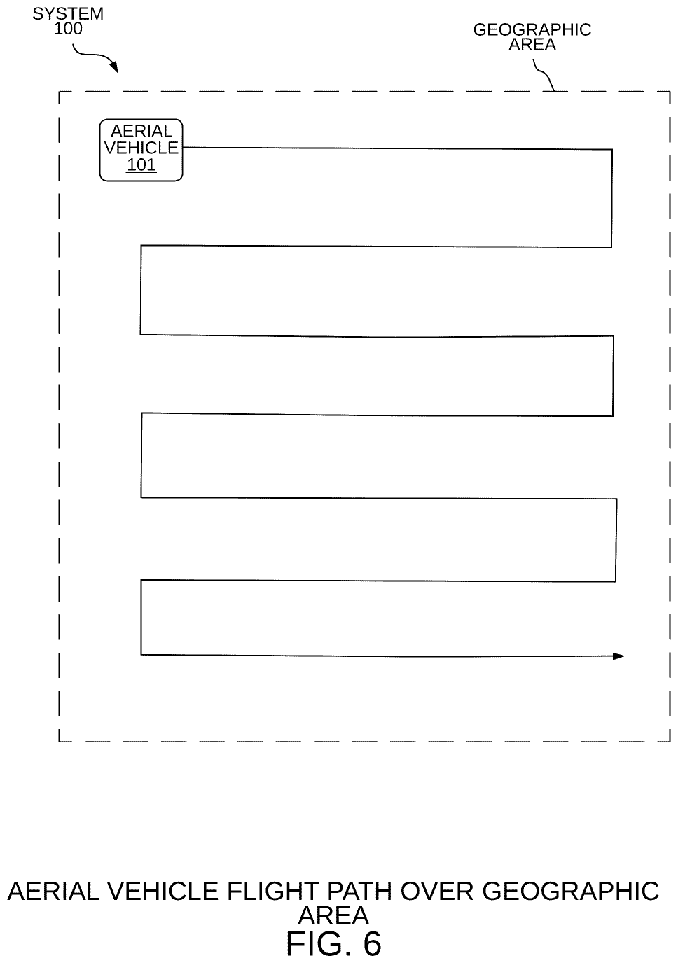

FIG. 6 is a diagram showing a flight path of the areal vehicle over a geographic area in accordance with one embodiment.

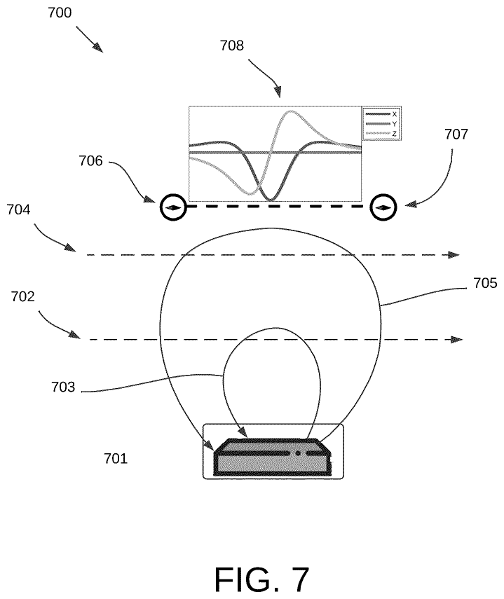

FIG. 7 shows a diagram of the matched filtering algorithm detection method 700. A magnetized object 701 generates a magnetic dipole field. When a sensor follows a low altitude path 702, the low altitude dipole field 703 is strong in a small region above the mine, and weak outside of that region. By contrast, the high altitude path 704 passes through a high altitude dipole field 705 that is much weaker, but extends further horizontally above the mine. The magnetic sensors 706 and 707 would observe a magnetic field signature 708 that has a very narrow horizontal extent when the sensors travel along the low altitude path 702, and a wide horizontal extent when traveling along the high altitude path 704. The magnetic field template must be adjusted based on the expected distance between the sensor and the magnetized object, as objects at different vertical positions can be differentiated. Note that the horizontal extent of the magnetic dipole field scales linearly with the altitude, so the field is twice as wide in the two horizontal directions when observed from twice the altitude. This means, although the magnetic field at higher altitudes is attenuated by the 1/r³ scaling of the dipole field, the matched filter has more measurement samples available, which improves the SNR. Because uncorrelated noise is incoherent and adds as root-sum-of-squares while the coherent matched filtering adds directly, doubling the number of measurement samples improves the SNR by the square root of 2. Therefore, using the matched filtering algorithm with a 1D template (a single flyover above the magnetized object) will improve the SNR scaling to 1/r^{2.5}, while applying a 2D template (including multiple flyovers not directly above the magnetized object) will improve the SNR scaling to 1/r², not accounting for possible attenuation due to differential measurements with insufficient sensor spacing.

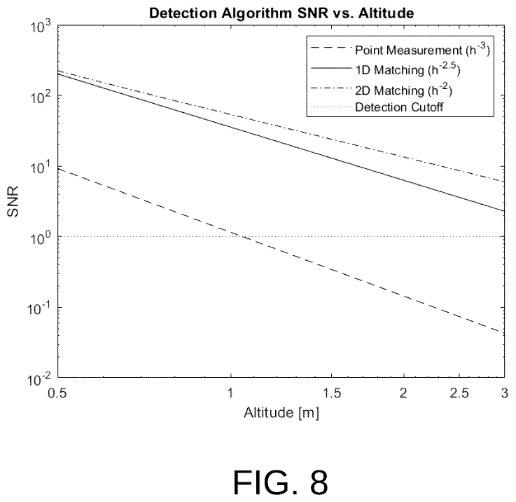

FIG. 8 compares the simulated SNR versus flight altitude for detection methods using magnetic field measurements from a single point, using a 1D template, and using a 2D template. The simulated detection system has a single 3-axis magnetometer with independent white gaussian noise with an RMS value of 100nT on each axis, and the detection target has a vertical dipole with a magnetization strength of 1 J/T. The horizontal spacing between flight passes for the 2D template was 0.5 meters. Observe that the slope of the SNR curves in the log-log plot coincides with the expected altitude scaling laws of 1/r³, 1/r^{2.5} and 1/r² for the respective detection methods. This graph does not model the SNR of a differential magnetometer (which may be separately accounted for by referring to FIGS. 4 and 5), but would be representative of a very long sensor bar. This simulation considers only a single template, the Z dipole template, and the SNR may be affected by the number of templates used and other parameters such as the velocity of the aerial vehicle, the sampling frequency of the magnetometers, whether the aerial vehicle directly passes over the potential object location, the error between the potential object location and the true object location, and the expected magnetization strength of detected objects.

Depending on the particular set of templates used, an additional step may be required to generate detection metrics from the matched filter results. For example, detection metrics may include the relative probability that a magnetized object is present at a location, or include physical parameters about the observed dipole fields at that location. The purpose of the detection metrics is to map a potentially large number of template results to a small set of measurements that indicate the presence or absence of a magnetized object. The sensor system SNR may be characterized for the matched filter results or the detection metrics, and the conversion between those SNR values is typically straightforward for simple detection metrics. Example detection metrics are described along with the exemplary embodiments below.

Note that the dipole field of a magnetized object has an orientation and a magnitude. An object magnetized in the vertical direction has a very strong field directly above the object, while an object magnetized in a horizontal direction has a weak field directly above the object, with the location of the peak magnetic field magnitude often being not directly above the object. With no information a priori about the objects to be detected in an environment, it is crucial that the magnetic field detection system is able to detect the magnetic fields from objects in any orientation. Because of the nature of the dipole field, the magnetic vector fields produced by objects magnetized in orthogonal basis directions, ex. North, West and Up, are orthogonal at every point. This means that the magnetic vector fields observed by a 3-axis magnetic field sensor passing over each of those orthogonal dipole fields will observe orthogonal magnetic field signature functions. This property means that, by using multiple sets of orthogonal templates each corresponding to the signature for a particular basis magnetization, the matched filter algorithm may not only detect magnetized objects with dipole fields in arbitrary orientations, but also separately extract each component of the object's magnetization vector in order to reconstruct the object's magnetic dipole field. The dipole field may be uniquely measured and reconstructed using only a single pass over the object with one or multiple 3-axis magnetometers. This approach is extremely powerful because it allows the outputs of the matched filter algorithm to be tied to a physical property of the object with physical units (ex. J/T for the magnetization), and the detection metrics may be configured to determine object parameters (ex. magnitude of the magnetization vector, and orientation of the dipole field) which may be used to determine object presence based on knowledge of the characteristics of expected objects.

There are multiple embodiments of the matched filter algorithm, particularly templates and metrics tailored to different detection systems. In the simplest embodiment, the sensor system includes a single magnetic field magnitude sensor (or, scalar magnetometer), observing the total magnetic field strength with no directional information. In this case, for each possible magnetized object location and magnetic field configuration, there is one template corresponding to the expected change in the magnetic field strength as the sensor passes above or near the magnetized object. The detection metric would directly be the output of the matched filter. The orientation of the magnetized object's dipole field significantly impacts the magnetic field magnitude signature observed, without the orthogonality advantages of the 3-axis approach, so caution should be taken, and potentially many templates should be used. A similar embodiment uses two or more scalar magnetometers to take differential measurements of the magnetic field magnitude, and then similarly applies templates according to expected object positions and field orientations.

In another embodiment, a single 3-axis magnetic field sensor is used. The magnetic field components along 3 axes are measured, providing the algorithm more measurements which can be used to detect the magnetized object with lower SNR. As discussed above, for each possible magnetized object location there are 3 basis magnetic field signatures needed to detect a dipole field in any orientation, so there are 9 template functions, with each basis magnetic field signature having a template for each of the 3 magnetometer axes (ex. X, Y and Z). A similar embodiment uses two or more 3-axis magnetometers to take differential measurements of the magnetic field vector, and then similarly applies the basis templates. Note that when the templates of expected magnetic field measurements are adjusted for the differential measurements (dependent on sensor spacing and sensor bar orientation relative to the flight path), the templates are typically still orthogonal, allowing detection and measurement of arbitrary orientation magnetic dipoles even in the differential case. Useful metrics in the 3-axis case may include the X, Y and Z components of the dipole field magnetization vector, obtained by summing the outputs of the X, Y and Z templates for a particular basis magnetization orientation; the magnitude of the dipole field magnetization, obtained as the typical vector magnitude on the magnetization vector components; the orientation of the magnetization vector, as a unit vector or in terms of heading and elevation angles derived from the magnetization vector components; or an optimized detection metric, as a linear combination of the template outputs with the weight for each template output optimized to achieve the theoretical optimal SNR for the particular sensor and flight characteristics.

The embodiments above rely on identifying the expected dipole field to be observed for a particular magnetized object. In practice when performing aerial surveys, there are an infinite number of potential locations for magnetized objects to be in, both at arbitrary horizontal positions and at arbitrary vertical positions, even below the ground. The flight path of the drone may also follow an inconsistent path due to error in the positioning system and environmental conditions like wind. One simple approach is to maintain a consistent template function across the entire flight, for example a 1D template, by assuming a constant drone velocity and only considering potential magnetized object locations directly under the flight path. A more sophisticated approach is to create a set of potential magnetized object locations to be considered, for example a uniform grid at ground level, and for each potential object location generate magnetic field templates based on the positions of the nearby magnetic field measurements along the drone flight path relative to the potential object location. This process creates a unique set of optimized templates for each potential object location, but care must be taken to ensure that the properties of the templates are somewhat consistent across the entire flight path. For example, if the drone flies very high in one location and very low in another location, the SNR will be very different across the drone flight path and could lead to confusion and false positives when processing the data.

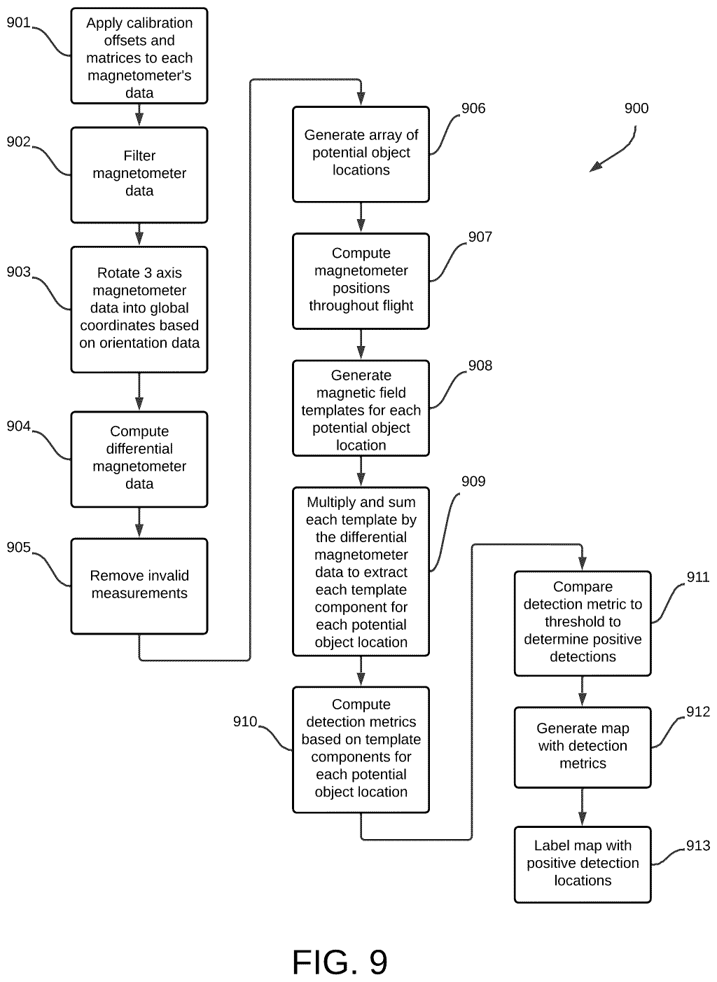

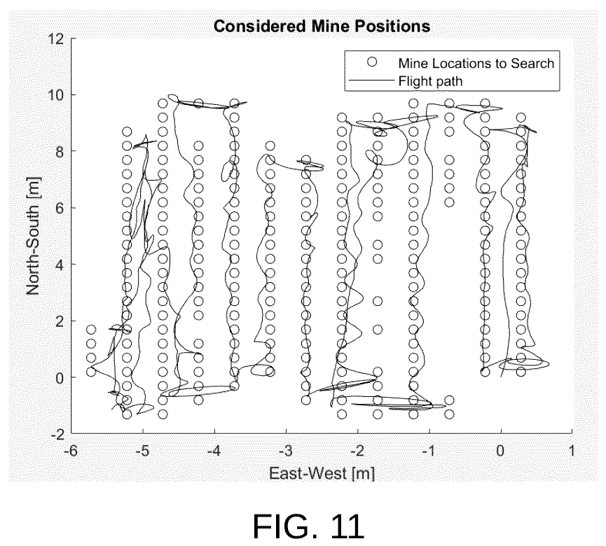

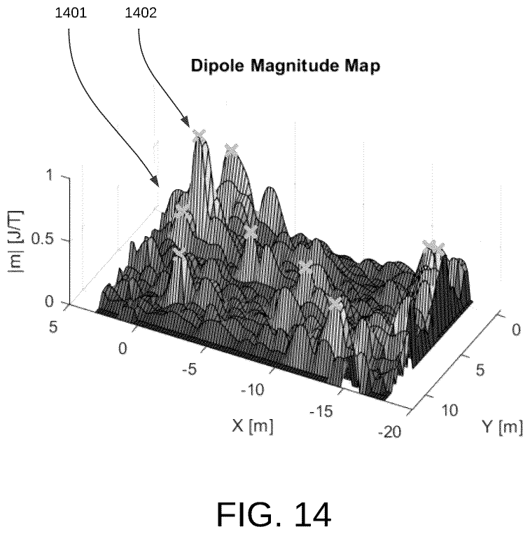

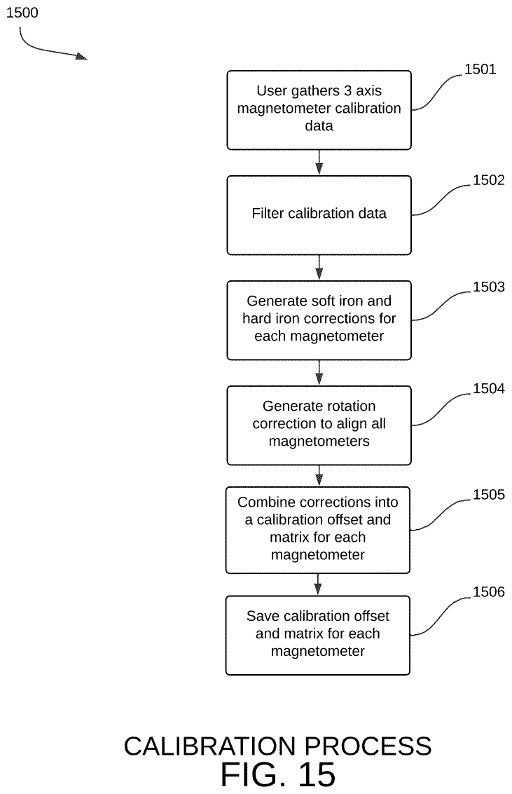

FIG. 9 illustrates an embodiment of magnetic field data analysis process 900. In an embodiment, the operations of method 900 may be performed by the processor of a computing device, such as the aerial vehicle's processor 208 or a computer at the aerial vehicle control station. The magnetic field data analysis process 900 assumes that magnetic field data from an aerial vehicle 201 flight has been collected, or is being collected, as the process may be applied during or after the data collection process. In optional block 901, magnetic field calibrations (described in FIG. 15) are applied to the magnetic sensor data. This block is optional because not all types of magnetic field sensors require calibration, or the calibration may be stored in the sensor itself. In optional block 902, the magnetic sensor data is filtered, to eliminate high frequency noise from motors and reduce the noise bandwidth. This block is optional because high frequency motor noise may not always be observed by the magnetic field sensors depending on their placement relative to the propulsion system 202, and the matched filter algorithm is mathematically equivalent to a bandpass filter which will eliminate high frequency noise. In block 903, the 3 axis magnetic field measurements are rotated from the sensor bar's local coordinate frame to the global coordinate system using orientation data to ensure consistency across the flight path. In block 904, the difference is taken between the two 3-axis magnetic field sensor readings to yield the differential 3-axis magnetic field data. In optional block 905, certain parts of the dataset are removed from the analysis process. These may include when the aerial vehicle takes off, lands, turns around or is at too high an altitude to obtain a useful measurement. In block 906, the flight path of the aerial vehicle is analyzed to generate a set of potential object locations, as shown in FIG. 11. In block 907, the drone flight path and sensor bar orientation are analyzed to solve for the position of each magnetic sensor during each magnetic field reading. This step may be reduced to synchronizing measurements of the drone's position with the magnetic field readings if a consistent template is used across the entire flight path. In block 908, magnetic field templates such as the embodiments described above are generated for each potential object location. In block 909, the matched filter algorithm is applied between each template and the magnetic field data for each potential object location. This is a vector dot product, where for a given template at a particular potential object location, each element is multiplied by the corresponding magnetic field measurement and the multiplication results are summed together to yield the matched filter output for that template. In block 910, detection metrics such as the embodiments described above are generated for each potential object location, based on the matched filter outputs from the previous step. In block 911, the detection metrics are compared to a detection threshold to determine whether a magnetized object is present at each potential object location. The detection threshold may be a single constant threshold; multiple thresholds based on one or more detection metrics; a single dynamically adjusted threshold, for example to maintain a constant false alarm rate (CFAR); or multiple dynamically adjusted thresholds. Clustering, peak detection or other methods may be used to combine nearby positive detections into a single positive detection of a magnetized object. In optional block 912, a map is generated indicating the values of detection metrics at each potential object location. The map may be a 2D heatmap; a 3D heatmap, as in FIG. 14; a 2D graphical or satellite image overlaid with an indicator of the detection metric values; or another visual indicator of the detection metric values at the potential object locations. This step is optional because the outputs of the detection system may be used without generating a map indicating the detection metrics. In optional block 913, the map of the previous step is labeled further with the potential object locations where the detection metric or metrics exceeded the detection threshold or thresholds. This step is optional because the map indicating detection metrics may be used without further labeling.

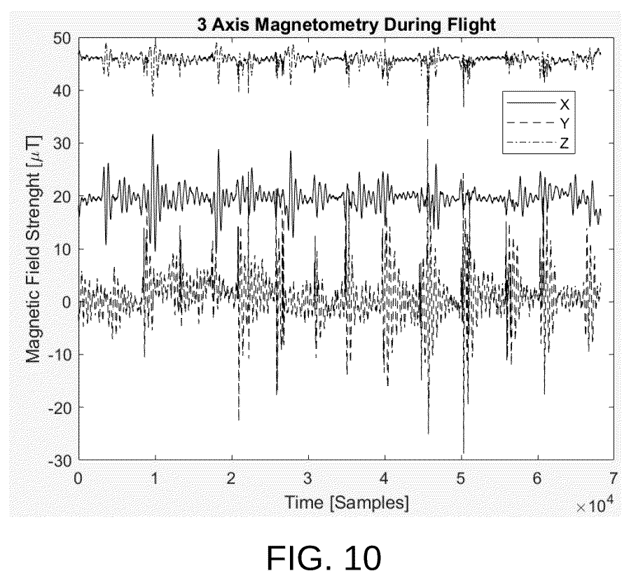

FIG. 10 shows an example of filtered 3-axis magnetometer data from experimental data of an early prototype, as would be the expected output of block 903. Note that the large constant offsets and the large fluctuation in magnetic field data as the sensor bar rotates in the global frame indicate the Earth's magnetic field (the motivation behind differential magnetometry) and imperfect calibration (discussed in FIG. 15) respectively.

FIG. 11 shows an example of an aerial vehicle flight path and the generated potential mine locations from experimental data of an early prototype, as would be the expected output of block 906. Note that the unusual flight path is due to strong winds and the nature of the early prototype, and that the potential object locations were generated from a uniform grid with locations too far from the flight path removed because the detection algorithm could not ensure high probability positive detections beyond a certain distance from the magnetized object.

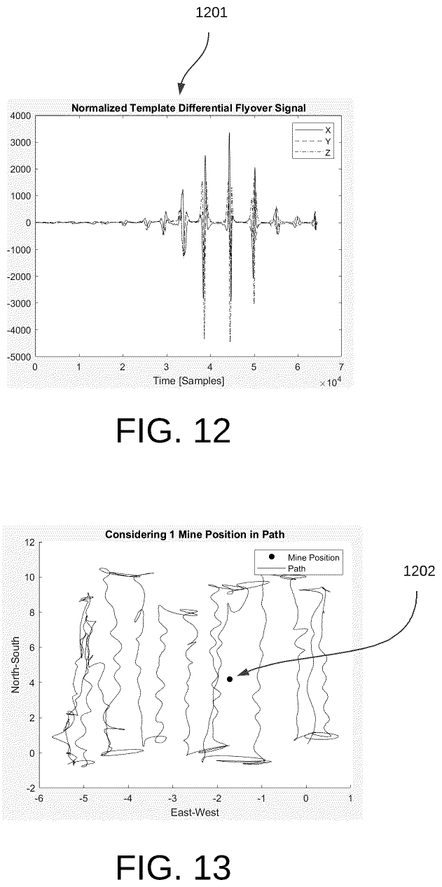

FIGS. 12 and 13 show an example of a differential 3-axis template 1201 for a particular potential object location 1202, based on experimental data from an early prototype. Note that this example is a 2D template, including the magnetic field measurements from multiple flight passes not directly above the potential object location.

FIG. 14 shows an example detection metric map 1401 rendered as a 3D heatmap, with example positive detections 1402 labeled on the map. This map is generated from experimental data of an early prototype.

FIG. 15 illustrates an embodiment magnetic field calibration process 1500, used to generate the magnetic field calibrations used by step 901 of the detection algorithm. This calibration process combines industry-standard soft iron and hard iron calibration with a rotational correction specifically for 3-axis differential sensors. In block 1501, magnetic field data for calibration is collected by the user. This typically involves rotating the magnetic field sensors through as many possible orientations as possible, to observe the Earth's magnetic field from all possible orientations. In optional block 1502, the magnetic field data is filtered to reduce the noise bandwidth. In block 1503, the magnetic field data is used to generate soft iron and hard iron corrections for each magnetic field sensor individually. A hard iron correction is a 3-element vector added to the magnetic field data, to compensate for constant magnetic fields in the sensor's frame of reference such as from permanent magnets in the motors. A soft iron correct is a 3-by-3 matrix the magnetic field measurements are multiplied by to transform the magnetic field calibration data, which may form an ellipsoid due to the magnetic permeability of components near the magnetometer, into a sphere as would be expected from observing the Earth's magnetic field from all orientations. This part of the calibration process is standard for 3-axis magnetic sensors. In block 1504, a rotational correction is found that aligns all the 3-axis magnetometers. This rotational correction is a 3-by-3 matrix, which optimally rotates each of the magnetometer's spheres of corrected magnetic field data such that the spheres become identical. Often this correction requires a scaling term to make the radii of the spheres equal, due to sensitivity differences between different magnetometers. The rotational correction may be adjusted to align the magnetometers with another element, such as the sensor bar processor 208. In block 1505, the soft iron correction and rotational correction for each magnetometer are combined into a single 3-by-3 correction matrix by matrix multiplication. This yields a calibration matrix and a calibration offset (which is the same as the hard iron correction vector from step 1503) for each magnetometer. In block 1506, the calibration matrix and calibration offset for each magnetometer are saved, for later use with the magnetic field data analysis process 900.

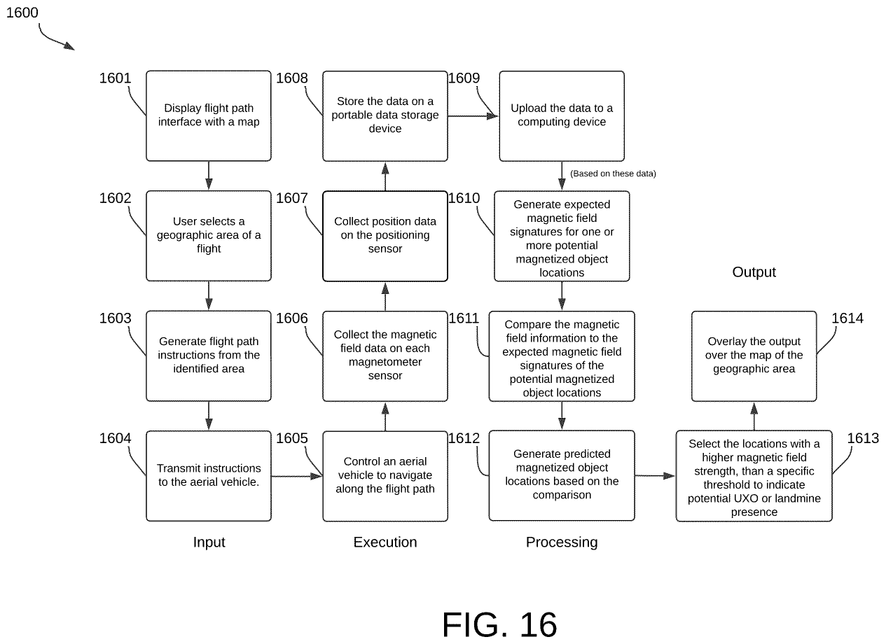

FIG. 16 illustrates a continuous method for operating an aerial vehicle equipped with two or more magnetic field sensors and analyzing and displaying the data for the user. The process is subdivided in four sections: Input, Execution, Processing, and Output. As part of Input, in block 1601 the user starts with the interface of a map where they can select the flight area of the aerial vehicle. In block 1602 the user selects the specific geographic area over which the aerial vehicle will be flown. In block 1603 the flight path is automatically generated over the identified area and in block 1604 the instructions are remotely transmitted to the aerial vehicle to start the operation. As part of the Execution, in block 1605 the aerial vehicle is automatically controlled to fly along the flight path, and simultaneously in blocks 1606 and 1607 the position and magnetic field data is collected and subsequently stored, as stated in block 1608, concluding the Execution. As part of the Processing, in block 1609 the collected data is uploaded to the same computing device as the one initiated the flight. In block 1610 of the method, the computing device generates expected magnetic field signatures for one or more potential magnetized object locations within the aerial vehicle's flightpath. Afterward, in block 1611 the computing device compares the collected magnetic field data to the expected magnetic field signatures of the potential magnetized object locations. In block 1612 we use the previous comparison to generate predicted locations of magnetized objects. Then in block 1613 we select locations based on a specific threshold for landmines and UXOs to indicate their potential presence. The block 1614 generates a map output with the processed detection results overlaid over the surveyed geographic area. All the processing and execution may happen within one embodiment software application, with a goal of creating an easy to use all-in-one system for surveying fields for the presence of landmines and UXOs or other magnetized objects.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A system comprising:
an aerial vehicle comprising:
a propulsion system extending a first length;
a sensor bar extending a second length, wherein the sensor bar has a first end and a second end, and wherein the second length is at least one and a half times the first length;
a first magnetic field sensor disposed at the first end of the sensor bar; and
a second magnetic field sensor disposed at the second end of the sensor bar.

2. The system of claim 1, wherein the propulsion system comprises:
a propeller;
a motor coupled to drive the propeller;
a memory that stores computer readable flight instructions; and
a processor, wherein when the computer readable flight instructions are executed or interpreted by the processor, the processor controls the aerial vehicle to traverse a flight path over a geographic area.

3. The system of claim 2, wherein when the computer readable flight instructions are executed or interpreted by the processor, the processor also controls the aerial vehicle to traverse the flight path at an elevation, and wherein the second length of the sensor bar is proportional to a range of expected flight path elevations.

4. The system of claim 3, wherein the magnetic field information is usable to identify a magnetized object within the geographic area.

5. The system of claim 1, further comprising:
a positioning system configured to generate position information of the aerial vehicle.

6. The system of claim 5, wherein the position system includes a Real-Time Kinematic (RTK) Global Positioning System (GPS).

7. The system of claim 1, wherein each of the first magnetic field sensor and the second magnetic field sensor is a magnetometer that detects magnetic field strength along at least two axes.

8. The system of claim 1, further comprising:
an energy storage system; and
an altitude sensor.

9. The system of claim 1, further comprising:
a magnetic field information analyzer, wherein the magnetic field information analyzer includes an analyzer processor and an analyzer memory that stores computer readable analyzer instructions that when executed or interpreted by the analyzer processor cause the magnetic field information analyzer to:
receive magnetic field information collected by the first magnetic field sensor and the second magnetic field sensor;
generate expected magnetic field signatures for one or more potential magnetized object locations;
compare the magnetic field information to the expected magnetic field signatures of the potential magnetized object locations; and
generate predicted magnetized object locations based on the comparison.

10. The system of claim 9, wherein the magnetic field information is compared to the expected magnetic field signatures using a matched filter, wherein when the computer readable analyzer instructions are executed or interpreted by the analyzer processor cause the magnetic field information analyzer to:
present a user interface on a display showing a map;
allow a user to draw a geographic area over the map shown on the display thereby generating flight path instructions; and
transmit the flight path instructions to the aerial vehicle.

11. The system of claim 10, wherein when the computer readable analyzer instructions are executed or interpreted by the analyzer processor cause the magnetic field information analyzer to:
overlay magnetized object information over the map of the geographic area.

12. A method comprising:
controlling an aerial vehicle to navigate along a path within a geographic area, wherein the aerial vehicle has a propulsion system and two or more magnetic field sensors disposed along opposite ends of a sensor bar, wherein the sensor bar has a sensor bar length that is at least one and a half times a propulsion system length;
collecting magnetic field information generated by the magnetic field sensors and position information while the aerial vehicle navigates along the path; and
analyzing the magnetic field information to predict a magnetized object within the geographic area.

13. The method of claim 12, wherein the analyzing of the magnetic field information to predict the magnetized object comprises:
generating expected magnetic field signatures for one or more potential magnetized object locations;
comparing the magnetic field information to the expected magnetic field signatures of the potential magnetized object locations; and
generating predicted magnetized object locations based on the comparison.

14. The method of claim 13, wherein the analyzing of the magnetic field information to predict the magnetized object further comprises:
presenting a flight path interface on a display showing a map to a user;
allowing the user to identify the geographic area over the map;
generating flight path instructions from the geographic area identified by the user via the flight path interface; and
transmitting the flight path instructions to the aerial vehicle.

15. The method of claim 14, wherein the analyzing of the magnetic field information to predict the magnetized object further comprises:
overlaying the magnetized object information over the map of the geographic area.

16. The method of claim 12, wherein the magnetic field information includes data points for each of magnetic field sensors, and wherein each data point has a latitude, a longitude, and magnetic field strengths along at least two axes.

17. The method of claim 12, further comprising:
configuring a magnetic field strength threshold that indicates whether the magnetized object is a Unexploded ordnance (UXO) or landmine.

18. An aerial vehicle comprising:
a propulsion system; and
means for collecting magnetic field information over a geographic area, wherein the magnetic field information is usable to predict presence of one or more magnetic objects by comparing collected magnetic field information to expected magnetic field signatures of potential magnetized objects within the geographic area.

19. The aerial vehicle of claim 18, wherein the means is a single magnetic field sensor.

20. The aerial vehicle of claim 18, wherein the means is a first magnetic field sensor and a second magnetic field sensor.

21. A method comprising:
receiving magnetic field information from one or more magnetic field sensors over a geographic area;
generating expected magnetic field signatures for one or more potential magnetized object locations within the geographic area;
comparing the magnetic field information to the expected magnetic field signatures of the potential magnetized object locations; and
generating predicted magnetized object locations based on the comparison.
